(19) United States
(12) Patent Application Publication
(10) Pub. No.: US 2014/0172224 A1
(43) Pub. Date: Jun. 19, 2014

(54) SPEED CONTROL IN AGRICULTURAL VEHICLE GUIDANCE SYSTEMS

(71) Applicant: AGCO Corporation, Duluth, GA (US)

(72) Inventors: Paul Matthews, Bel Aire, KS (US); Vincent Nickel, Peabody, KS (US)

(73) Assignee: AGCO Corporation, Duluth, GA (US)

(21) Appl. No.: 14/109,984

(22) Filed: Dec. 18, 2013

Related U.S. Application Data
(60) Provisional application No. 61/739,049, filed on Dec. 19, 2012.

(51) Int. Cl. G05D 1/02

(52) U.S. Cl. CPC G05D 1/0223
USPC 701/25

(57) ABSTRACT

Speed control in agricultural vehicle guidance systems may be provided. First, an auto-guidance processor may be loaded with a wayline. A drive component coupled to the auto-guidance processor may be engaged to cause the agricultural vehicle to traverse the wayline. The wayline may define a path for the agricultural vehicle to travel within an area. The auto-guidance processor may receive inclination data. The agricultural vehicle's speed may be altered as the agricultural machine traverses the wayline based upon the inclination data.

### CROSS REFERENCE TO RELATED APPLICATION

This application claims the benefit of U.S. Provisional Application No. 61/739,049, entitled SPEED CONTROL IN AGRICULTURAL VEHICLE GUIDANCE SYSTEMS filed Dec. 19, 2012, which is hereby incorporated by reference in its entirety.

### BACKGROUND OF THE INVENTION

1. Field of Invention

This invention relates to speed control in agricultural vehicle guidance systems, and more particularly to using inclination data to control the speed the agricultural vehicle may traverse a wayline.

2. Description of Related Art

Vehicle guidance systems are used in many types of agricultural vehicles to assist operators in reaching a desired location and/or following a desired path. For instance, vehicle guidance systems may use control algorithms to direct agricultural vehicles from point to point. In other words, tractors, combines, sprayers, and other agricultural vehicles may be equipped with vehicle guidance systems to assist operators in following a desired route across a field.

### OVERVIEW OF THE INVENTION

In one embodiment, the invention is directed to a method for speed control in agricultural vehicle guidance systems. First, an auto-guidance processor may be loaded with a wayline. A drive component coupled to the auto-guidance processor may be engaged to cause the agricultural vehicle to traverse the wayline. The wayline may define a path for the agricultural vehicle to travel within an area. The auto-guidance processor may receive inclination data. The agricultural vehicle's speed may be altered as the agricultural machine traverses the wayline based upon the inclination data.

Another embodiment may comprise an inertial sensor system, a drive component operative to propel an apparatus and an auto-guidance processor coupled to the drive component and the inertial sensor system. The auto-guidance processor may be operative to load a wayline. The drive component coupled to the auto-guidance processor may be engaged to cause the agricultural vehicle to traverse the wayline. The wayline may define a path for the agricultural vehicle to travel within the area. The auto-guidance processor may be operative to receive inclination data from the inertial sensor system and alter the agricultural vehicle's speed based upon the inclination data.

Yet another embodiment may comprise a memory storage and a processing unit coupled to the memory storage. The processing unit may be operative to load a wayline. The wayline may define a path for the apparatus to follow. The processing unit may be further operative to engage a drive component to propel the apparatus along the wayline at a speed and receive inclination data from an inertial sensor system. The speed may be altered by the processing unit as the apparatus follows the wayline based on the inclination data.

Speed control in agricultural vehicle guidance systems may be provided. First, an auto-guidance processor may be loaded with a wayline. A drive component coupled to the auto-guidance processor may be engaged and cause the agricultural vehicle to traverse the wayline. The wayline may define a path for the agricultural vehicle to travel within an area. The auto-guidance processor may receive inclination data. The agricultural vehicle's speed may be altered as the agricultural machine traverses the wayline based upon the inclination data.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIGS. 1A and 1B show an operating environment;

FIG. 2 shows an auto-guidance processor;

FIG. 3 shows a flow chart of a method for providing speed control in agricultural vehicle guidance systems; and

FIG. 4 shows a flow chart of a subroutine for altering speed.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

An auto-guidance system may automatically steer an agricultural vehicle (e.g., a tractor, a combine, or a sprayer) along a predefined path (e.g., a wayline) within an area (e.g., a farm or field). The area may have a topology that may necessitate the agricultural vehicle operating at different speeds. For example, when the agricultural vehicle is operating on a hillside, a slower speed may be needed to maintain the agricultural vehicle's stability.

The auto-guidance system may receive inclination data from an inertial sensor system. The inertial sensor system may comprise, for example, motion sensors, accelerometers, rotation sensors, and gyroscopes. The inertial sensor system may monitor, continuously or intermittently, the agricultural vehicle's position, orientation, and velocity. As the agricultural vehicle traverses the wayline, the auto-guidance system may alter the agricultural vehicle's speed based upon the inclination data.

The inclination data may comprise data describing the agricultural vehicle's orientation with respect to predefined axes. For example, the inclination data may contain data describing the agricultural vehicle's pitch and roll angles relative to horizontal and vertical axes. In addition, the inclination data may comprise data describing rate changes in the agricultural vehicle's pitch and roll angles. For example, the inclination data may comprise data specifying how fast the agricultural vehicle's pitch and roll angles may be changing.

The inclination data may be directly measured or a calculated value. For example, the agricultural vehicle's inclination angle and/or rate of change of inclination may be directly measured. In addition, using the inclination angle, the rate of change of inclination may be calculated.

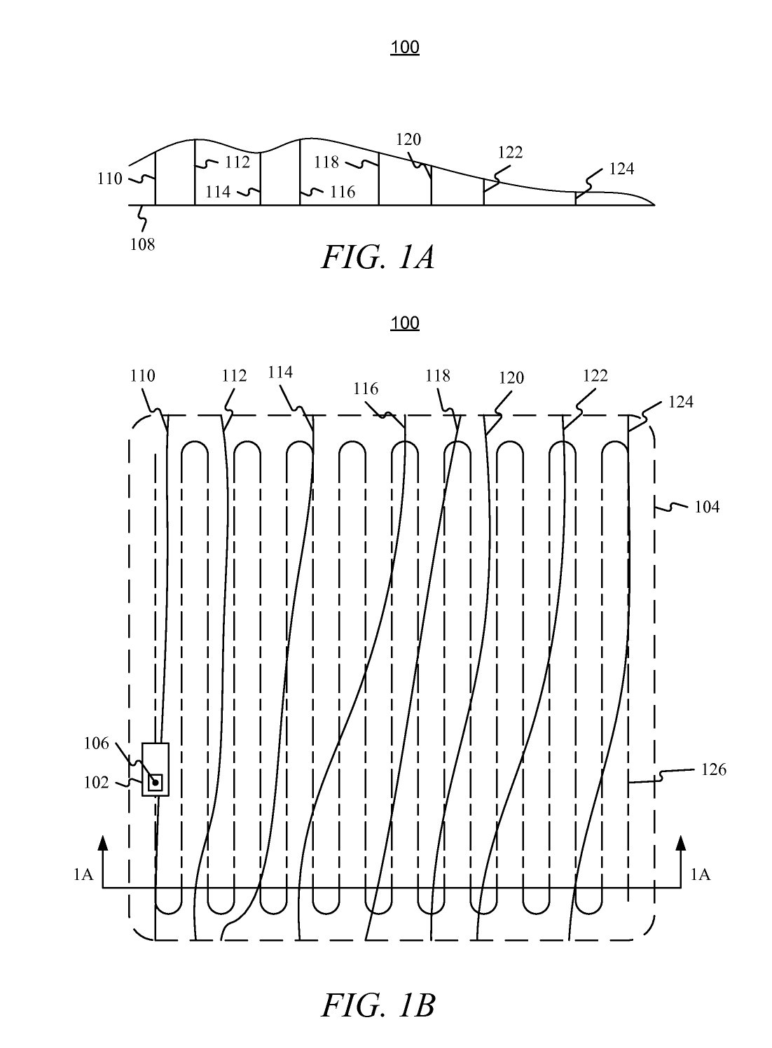

FIGS. 1A and 1B show an operating environment 100 (e.g., a farm) for providing speed control in agricultural vehicles. Operating environment 100 may comprise an agricultural vehicle 102 operating within an area (e.g., a field 104). Agricultural vehicle 102 may comprise an auto-guidance processor 106. Examples of agricultural vehicle 102 may include an agricultural implement, comprising, but not limited to, a tractor, a combine, or a sprayer.

Field 104 may comprise terrain at varying heights above a reference datum 108. Reference datum 108 may be any arbitrary point comprising, but not limited to, sea level, a lowest point in field 104, or a highest point in field 104. The varying heights may be represented by a plurality of contour lines (e.g., a first contour line 110, a second contour line 112, a third contour line 114, a fourth contour line 116, a fifth contour line 118, a sixth contour line 120, a seventh contour line 122, and an eighth contour line 124). In other words, each of the plurality of contour lines may represent a particular height above reference datum 108 or each contour line may represent an increase or decrease in elevation (e.g., ±25 feet). For example, first contour line 110, third contour line 114, and fifth contour line 118 may represent a distance of 100 feet above reference datum 108 and second contour line 112 may represent a +25 feet increase to 125 feet above reference datum 108.

A wayline 126 may traverse field 104. Wayline 126 may define a predetermined path agricultural vehicle 102 may travel. While FIG. 1B shows a single wayline, field 104 may comprise multiple waylines. The waylines may be straight, curved, etc.

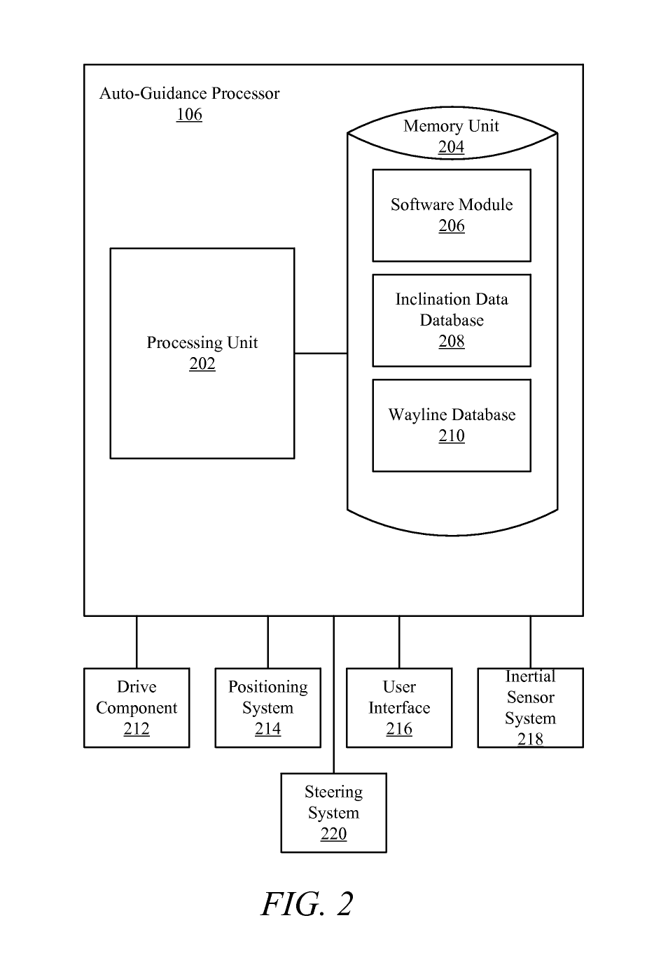

FIG. 2 shows auto-guidance processor 106 in more detail. As shown in FIG. 2, auto-guidance processor 106 may include a processing unit 202 and a memory unit 204. Memory unit 204 may include a software module 206, an inclination data database 208, and a wayline database 210. Inclination data database 208 may comprise a plurality of inclination data such as, for example, maximum speeds for given inclination angles or rates of change in inclination angles. Wayline database 210 may comprise data on a plurality of waylines.

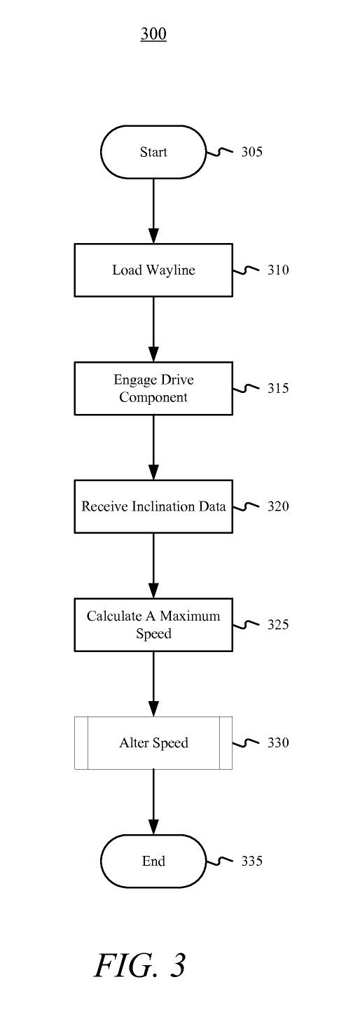

Auto-guidance processor 106 may also be operatively connected a drive component 212. Drive component 212 may comprise an engine and a steering linkage (not shown) for controlling movement of agricultural vehicle 102. While executing on processing unit 202, software module 206 may perform processes for providing speed control in agricultural vehicle guidance systems, including, for example, one or more stages included in method 300 described below with respect to FIG. 3.

A positioning system 214 may be connected to auto-guidance processor 106. Positioning system 214 may determine the location of agricultural vehicle 102 or receiving information that may be used to determine agricultural vehicle 102's position. Examples of positioning system 214 may include, for example, the Global Positioning System (GPS), cellular signals, etc.

A user interface 216 may be connected to auto-guidance processor 106. User interface 216 may allow an operator to input data into auto-guidance processor 106 through a keypad, a touch screen, etc. In addition, user interface 216 may allow auto-guidance processor 106 to present information to the operator, for example, via a display. For example, the operator may use user interface 216 to input speed data and user interface 216 may present the operator with visual and audible alarms when agricultural vehicle 102 exceeds a maximum speed.

An inertial sensor system 218 may be connected to auto-guidance processor 106. Inertial sensor system 218 may comprise, for example, motion sensors, accelerometers, rotation sensors, and gyroscopes. Inertial sensor system 218 may monitor, continuously or intermittently, agricultural vehicle 102's position, orientation, and velocity. As the agricultural vehicle 102 traverses wayline 126, the auto-guidance system may alter agricultural vehicle 102's speed based upon the inclination data.

A steering system 220 may be connected to auto-guidance processor 106. Steering system 220 may comprise, for example, servos, motors, and sensors that may be connected to steering components (e.g., rack and pinion, steering linkages, etc.). Steering system 220 may monitor, continuously or intermittently, agricultural vehicle 102's trajectory and adjust wheel orientation to guide agricultural vehicle 102's trajectory. For instance, as the agricultural vehicle 102 traverses wayline 126, steering system 220 may alter agricultural vehicle 102's trajectory to follow wayline 126.

Inclination data database 208 may store maximum speeds for given inclination angles of agricultural vehicle 102. For example, inclination data database 208 may comprise an array. Within the array, inclination angles may be stored with corresponding maximum speeds. The maximum speeds may be based on multiple parameters such as, for example, agricultural vehicle type, weight, loading, and stability characteristics. The agricultural vehicle type and weight, loading, and stability characteristics may be indices within the array. In addition to inclination angles, maximum speeds for rates of change in agricultural vehicle 102's inclination angle may be store in inclination data database 208.

The data stored in inclination data database 208 may be updated in real-time. For instance, if agricultural vehicle 102 is a sprayer, the sprayer's weight, loading, and stability characteristics may change as it traverses field 104. Auto-guidance processor 106 may update inclination data database 208 to reflect the changes.

Auto-guidance processor 106 (“the processor”) may be implemented using an onboard engine control unit (ECU), a personal computer, a network computer, a mainframe, or other similar microcomputer-based workstation. The processor may be located on agricultural vehicle 102 or may be in a remote location. For instance, in an agricultural environment, the processor may comprise a computer located at a central location (e.g., a farm's central equipment storage and maintenance facility).

The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise a mobile terminal, such as a smart phone, a cellular telephone, a cellular telephone utilizing wireless application protocol (WAP), personal digital assistant (PDA), intelligent pager, portable computer, a hand held computer, or a wireless fidelity (Wi-Fi) access point. The aforementioned systems and devices are examples and the processor may comprise other systems or devices.

FIG. 3 is a flow chart setting forth the general stages involved in a method 300 for providing speed control in agricultural vehicle guidance systems. Method 300 may be implemented using, for example, auto-guidance processor 106 as described in more detail above. Ways to implement the stages of method 300 will be described in greater detail below.

Method 300 may begin at starting block 305 and proceed to stage 310 where auto-guidance processor 106 may load a wayline. The wayline may be selected from the plurality of waylines stored in wayline database 210. The operator or auto-guidance processor 106 may select the wayline to be loaded. For example, when the operator drives agricultural vehicle 102 into a particular area (e.g., field 104) the operator may select wayline 126. In addition, when the operator drives agricultural vehicle 102 into field 104, auto-guidance processor 106 may determine that agricultural vehicle 102 is located in field 104 and automatically select wayline 126.

From stage 310 where the wayline is loaded, method 300 may proceed to stage 315 where auto-guidance processor 106 may engage drive component 212. For example, auto-guidance processor 106 may send a signal to agricultural vehicle 102's engine and cause agricultural vehicle to move forward at a given speed (e.g., 10 mph). In addition, auto-guidance processor 106 may control the steering linkage and cause agricultural vehicle 102 to turn in various directions. For instance, once engaged, drive component 212 may cause agricultural vehicle 102 to traverse wayline 126 at the given speed.

From stage 315 where drive component 212 is engaged, method 300 may proceed to stage 320 where auto-guidance processor 106 may receive inclination data from inertial sensor system 218. Agricultural vehicle 102's inclination angle may be measured relative to horizontal or vertical axes. In addition, agricultural vehicle 102's inclination angle may be measured in the pitch, roll, and yaw axes. For example, inertial sensor system 218 may comprise a gyroscope and as agricultural vehicle 102 traverses wayline 126, inertial sensor system 218's gyroscope may measure agricultural vehicle 102 pitch and roll angles as well as changes in agricultural vehicle 102's pitch and roll angles.

Inertial sensor system 218 may then transmit the measurements or detected changes to auto-guidance processor 106. For instance, inertial sensor system 218 may measure agricultural vehicle 102's inclination angle at a given frequency (e.g., 60 Hz). Using the inclination angle measurements auto-guidance processor 106 and/or inertial sensor system 218 may calculate the inclination angle rate of change of agricultural vehicle 102.

From stage 320 where auto-guidance processor 106 receives the inclination data, method 300 may proceed to stage 325 where a maximum speed may be calculated based upon the inclination data. For example, auto-guidance processor 106 may use the inclination data to determine that agricultural vehicle 102 may be on a hillside and/or turning. For instance, agricultural vehicle 102 may be traversing a steep hillside and, based on wayline 126, may turn to travel uphill. This configuration may place agricultural vehicle 102 in an unstable position if it is traveling too fast. As such, auto-guidance processor 106 may use agricultural vehicle 102's weight and balance information along with the inclination data to determine the maximum speed. Furthermore, the maximum speed may be a function of an implement attached to agricultural vehicle 102. For example, agricultural vehicle 102 may be a tractor pulling a plow. The maximum speed for this configuration may be X mph. In another configuration, the tractor may be pulling a trailer. In this configuration the maximum speed may be Y mph.

The maximum speed may be selected from the array stored in inclination data database 208. For instance, as agricultural vehicle 102 travels a hillside, it may have a fixed inclination angle. The array may contain a listing of maximum speeds for given inclination angles. For example, for an inclination angle of 3 degrees, the array may contain a corresponding maximum speed of 20 mph to be set as the maximum speed.

Furthermore, setting the maximum speed may comprise increasing and decreasing the maximum speed. For example, the maximum speed may be set at a current value of X mph. When a new maximum speed is set, it may be set at a higher or lower speed that X mph.

In addition, the array may contain maximum speeds for the inclination angle rates of change. For example, as agricultural vehicle 102 turns, its inclination angle may change. For instance, as agricultural vehicle 102 enters a turn it may pitch into and roll opposite the turn's direction. Inertial sensor system 218 may detect the changes in pitch and roll and send the rates of change to auto-guidance processor 106. Auto-guidance processor 106 may use the inclination angle rate of change to select the maximum speed from the array.

Furthermore, auto-guidance processor 106 may use a formula to calculate the maximum speed. For instance, the maximum speed may be a function of agricultural vehicle 102's weight, vehicle type (e.g., tractor, sprayer, etc.), wheelbase, inclination angle, the inclination angle's rate of change, etc. Auto-guidance processor 106 may receive the inputs to the function and calculate the maximum speed. Furthermore, calculating the maximum speed may comprise increasing and decrease the maximum speed.

Agricultural vehicle 102's operating speed does not have to be the maximum speed. For example, the agricultural vehicle 102's operator may choose to operate agricultural vehicle 102 at a speed below the maximum speed. However, the maximum speed may be an upper limit that the operator and/or auto-guidance processor 106 may operate agricultural vehicle 102.

From stage 325 where auto-guidance processor 106 calculates the maximum speed, method 300 may proceed to subroutine 330 where auto-guidance processor 106 may alter agricultural vehicle 102's speed. Auto-guidance processor 106 may alter agricultural vehicle 102's speed as it traverses wayline 126 based upon the inclination data. For example, as agricultural vehicle 102 enters a turn, auto-guidance processor 106 receive the inclination data and may slow agricultural vehicle 102's speed based upon the inclination data. In addition, as agricultural vehicle 102 exits the turn, auto-guidance processor 106 may increase agricultural vehicle 102's speed based upon received inclination data.

In subroutine 330, auto-guidance processor 106 may alter agricultural vehicle 102's speed based upon a rate of change of inclination angle. For example, as agricultural vehicle 102 transitions from relatively flat terrain or during a turn, agricultural vehicle 102's inclination angle may change. Depending on the maximum speed for the change in inclination angle, auto-guidance processor 106 may slow agricultural vehicle 102 if its current speed exceeds the maximum speed. In addition, auto-guidance processor 106 may increase agricultural vehicle 102's speed if its current speed is below the maximum speed.

Auto-guidance processor 106 may alter agricultural vehicle 102's speed based upon a roll rate and/or a pitch rate. For example, agricultural vehicle 102 may be traveling on a straight portion of wayline 126, which may also be undulating terrain. As agricultural vehicle 102 travels wayline 126 it may roll from side to side causing a roll rate. Auto-guidance processor 106 may receive a roll rate and calculate or select a maximum speed based on the roll rate. In subroutine 330, auto-guidance processor 106 may slow agricultural vehicle 102 if its current speed exceeds the maximum speed. In addition, auto-guidance processor 106 may increase agricultural vehicle 102's speed if its current speed is below the maximum speed.

Auto-guidance processor 106 may alter agricultural vehicle 102's speed based upon a maximum inclination angle. For example, agricultural vehicle 102 may be traveling on relatively flat terrain at a maximum speed and may transition to inclined terrain. The maximum speed may have a maximum inclination angle associated with it. For instance, while operating at 20 mph agricultural vehicle 102 may have a maximum inclination angle of 5 degrees. As agricultural vehicle 102 travels wayline 126, its inclination angle may increase above the maximum inclination angle. Auto-guidance processor 106 may receive agricultural vehicle 102's current inclination angle. Auto-guidance processor 106 may slow agricultural vehicle 102 if the received inclination angle exceeds the maximum inclination angle. In addition, auto-guidance processor 106 may increase agricultural vehicle 102's speed if its current inclination angle is below the maximum inclination angle.

From subroutine 330 where auto-guidance processor 106 alters agricultural vehicle 102's speed, method 300 may end at termination block 335. Method 300 may repeat at regular intervals. For example, method 300 may repeat every 1 second, 10 seconds, etc.

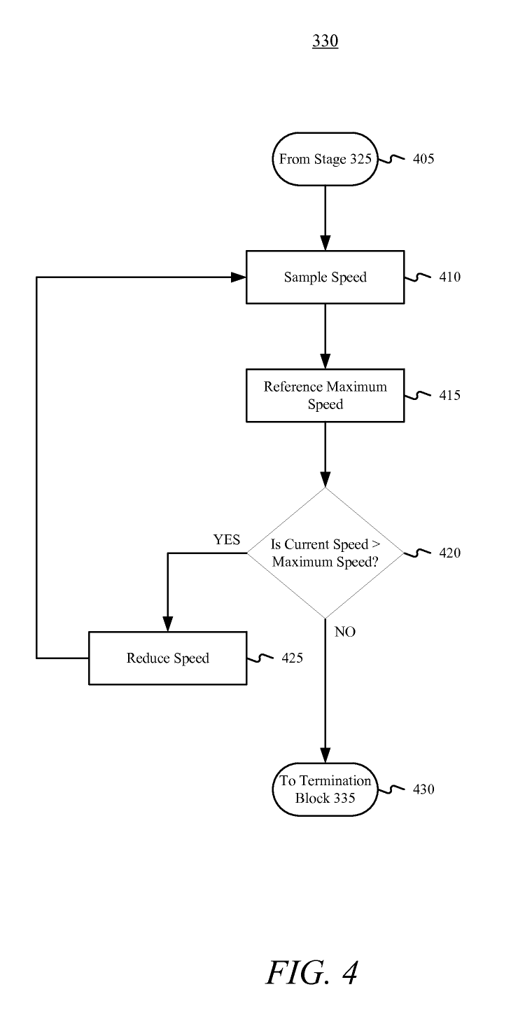

FIG. 4 is a flow chart setting forth the general stages involved in subroutine 330 for altering the speed of agricultural vehicle 102. Subroutine 330 may be implemented using, for example, auto-guidance processor 106 as described in more detail above. Ways to implement the stages of subroutine 330 will be described in greater detail below.

Subroutine 330 may begin at starting block 405 and proceed to stage 410 where auto-guidance processor 106 may sample a current speed of agricultural vehicle 102. For example, auto-guidance processor 106 may receive agricultural vehicle 102's speed from drive component 212. In addition, auto-guidance processor 106 may calculate agricultural vehicle 102's speed based on position data received from positioning system 214.

From stage 410 where auto-guidance processor 106 samples the current speed, subroutine 330 may proceed to stage 415 where auto-guidance processor 106 may reference the maximum speed. For example, in stage 415 auto-guidance processor 106 may reference the maximum speed calculated in stage 325. From stage 415 where auto-guidance processor 106 references the maximum speed, subroutine 330 may proceed to decision block 420 where auto-guidance processor 106 may determine if agricultural machine 102's speed is above the maximum speed. Auto-guidance processor 106 may determine of agricultural machine 102's speed is greater than the maximum speed using arithmetic operations.

If the current speed is greater than the maximum speed, subroutine 330 may proceed to stage 425 where auto-guidance processor 106 may reduce the speed of agricultural machine 102. For example, auto-guidance processor 106 may send a signal to drive component 212. The signal may be configured to cause the drive component to reduce the engine output. The engine output may be reduced by reducing engine rpms, reducing the fuel flowrate, and/or constricting the air intake to the engine. After reducing the engine output, subroutine may proceed to repeat stage 410, stage 415, and decision block 420 to determine if the reduction in speed has reduced agricultural vehicle 102's speed below the maximum speed. If the current speed is below the maximum speed, subroutine may terminate and return to termination block 335 at termination block 430.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

What is claimed is:

1. A method comprising:
loading, into an auto-guidance processor, a wayline defining a path for an agricultural vehicle to travel;
engaging a drive component to cause the agricultural vehicle to traverse the wayline;
receiving, at the auto-guidance processor, inclination data of the agricultural machine; and
altering a speed of the agricultural machine as it traverses the wayline based on the inclination data.

2. The method of claim 1,
wherein receiving inclination data comprises receiving an inclination rate of change, and
wherein altering the speed comprises altering the speed based upon the inclination angle rate of change.

3. The method of claim 1,
wherein receiving the inclination data comprises receiving a roll rate and a pitch rate of the agricultural machine, and
wherein altering the speed comprises reducing the speed of the agricultural machine when the roll rate exceeds a maximum roll rate and the pitch rate exceeds a maximum pitch rate.

4. The method of claim 1,
wherein receiving the inclination data comprises receiving an inclination angle of the agricultural machine, and
wherein altering the speed of the agricultural machine comprises reducing the speed when the inclination angle exceeds a maximum inclination angle.

5. The method of claim 1,
wherein receiving the inclination data comprises receiving an inclination angle of the agricultural machine, and
wherein altering the speed of the agricultural machine comprises increasing the speed based upon the inclination angle.

6. The method of claim 1,
wherein receiving the inclination data comprises receiving an inclination angle of the agricultural machine, and
wherein altering the speed of the agricultural machine comprises increasing a maximum speed of the agricultural machine based on the inclination angle.

7. The method of claim 1,
wherein receiving the inclination data comprises receiving a rate of change of inclination, and
wherein altering the speed of the agricultural machine comprises altering the speed as a function of the rate of change of inclination.

8. An apparatus comprising:
an inertial sensor system;
a drive component operative to propel the apparatus; and
an auto-guidance processor coupled to the drive component and the inertial sensor system, the auto-guidance processor operative to:
engage the drive component to propel the apparatus along a wayline at a speed, the wayline defining a path for the apparatus to follow,
receive inclination data from the inertial sensor system, and
alter the speed as the apparatus follows the wayline in response to receiving the inclination data.

9. The apparatus of claim 8,
wherein the auto-guidance processor operative to receive inclination data comprises the auto-guidance processor operative to receive an inclination angle rate of change, and
wherein the auto-guidance processor operative to alter the speed comprises the auto-guidance processor operative to alter the speed based upon the inclination angle rate of change.

10. The apparatus of claim 8,
wherein the auto-guidance processor operative to receive the inclination data comprises the auto-guidance processor operative to receive a roll rate of the apparatus, and
wherein the auto-guidance processor operative to alter the speed comprises the auto-guidance processor operative to reduce the speed of the apparatus when the roll rate exceeds a maximum roll rate.

11. The apparatus of claim 8,
wherein the auto-guidance processor operative to receive the inclination data comprises the auto-guidance processor operative to receive an inclination angle of the apparatus, and
wherein the auto-guidance processor operative to alter the speed of the apparatus comprises the auto-guidance processor operative to reduce the speed when the inclination angle exceeds a maximum inclination angle.

12. The apparatus of claim 8,
wherein the auto-guidance processor operative to receive the inclination data comprises the auto-guidance processor operative to receive an inclination angle of the apparatus, and
wherein the auto-guidance processor operative to alter the speed of the apparatus comprises the auto-guidance processor operative to increase the speed based upon the inclination angle.

13. The apparatus of claim 8,
wherein the auto-guidance processor operative to receive the inclination data comprises the auto-guidance processor operative to receive an inclination angle of the apparatus, and
wherein the auto-guidance processor operative to alter the speed of the apparatus comprises the auto-guidance processor operative to reduce a maximum speed of the apparatus based on the inclination angle.

14. The apparatus of claim 8,
wherein the auto-guidance processor operative to receive the inclination data comprises the auto-guidance processor operative to receive a rate of change of inclination, and
wherein the auto-guidance processor operative to alter the speed of the apparatus comprises the auto-guidance processor operative to alter the speed as a function of the rate of change of inclination.

15. An apparatus comprising:
a memory storage; and
a processing unit coupled to the memory storage, wherein the processing unit is operative to:
engage a drive component to propel the apparatus along a wayline at a speed, the wayline defining a path for the apparatus to follow,
receive inclination data from an inertial sensor system, and
alter the speed as the apparatus follows the wayline in response to receiving the inclination data.

16. The apparatus of claim 15,
wherein the processing unit operative to receive inclination data comprises the processing unit operative to receive a rate of change of inclination, and
wherein the processing unit operative to alter the speed comprises the processing unit operative to alter the speed based upon the rate of change of inclination.

17. The apparatus of claim 15,
wherein the processing unit operative to receive the inclination data comprises the processing unit operative to receive a roll rate of the apparatus, and
wherein the processing unit operative to alter the speed comprises the processing unit operative to reduce the speed of the apparatus when the roll rate exceeds a maximum roll rate.

18. The apparatus of claim 15,
wherein the processing unit operative to receive the inclination data comprises the processing unit operative to receive an inclination angle of the apparatus, and
wherein the processing unit operative to alter the speed of the apparatus comprises the processing unit operative to reduce the speed when the inclination angle exceeds a maximum inclination angle.

19. The apparatus of claim 15,
wherein the processing unit operative to receive the inclination data comprises the processing unit operative to receive an inclination angle of the apparatus, and
wherein the processing unit operative to alter the speed of the apparatus comprises the processing unit operative to increase the speed based upon the inclination angle.

20. The apparatus of claim 15,
wherein the processing unit operative to receive the inclination data comprises the processing unit operative to receive an inclination angle of the apparatus, and
wherein the processing unit operative to alter the speed of the apparatus comprises the processing unit operative to increase a maximum speed of the apparatus based upon the inclination angle.
